(19) United States
(12) Patent Application Publication
(10) Pub. No.: US 2025/0377206 A1
(43) Pub. Date: Dec. 11, 2025

(54) FAULT-TOLERANT COLLABORATIVE POSITIONING METHOD AND SYSTEM FOR INTELLIGENT CONNECTED VEHICLES

(71) Applicant: Chang'an University, Xi'an (CN)

(72) Inventors: Haigen Min, Xi'an (CN); Xia Wu, Xi'an (CN); Xiangmo Zhao, Xi'an (CN); Lisha Chen, Xi'an (CN); Wuqi Wang, Xi'an (CN); Shengsheng Xing, Xi'an (CN); Shixiang Chen, Xi'an (CN); Sen Xia, Xi'an (CN)

(21) Appl. No.: 19/093,308

(22) Filed: Mar. 28, 2025

(30) Foreign Application Priority Data
Jun. 5, 2024 (CN) 202410724047.6

(51) Int. Cl. G01C 21/28; G07C 5/00; G07C 5/02

(52) U.S. Cl. CPC G01C 21/28; G07C 5/008; G07C 5/02

(57) ABSTRACT

A fault-tolerant intelligent connected vehicle collaborative positioning method and system are provided, which relates to the field of intelligent connected vehicle positioning technologies. An iterative fusion of Gaussian belief propagation is performed on pre-processed information of longitude, latitude and altitude of a current position of a vehicle, data of angular velocity, traveling velocity, acceleration, wheel speed, steering angle and mileage of the vehicle and calibrated estimated value of the relative distance between the vehicle and a cooperative vehicle, to obtain a resultant position of the vehicle. By fusing measurement values of various sensors including the information of longitude, latitude and odometer of the vehicle, and vehicle-to-vehicle distance, integrity of collaborative positioning data is ensured. A fault detection and elimination method is performed in a graph model, which ensures fault-tolerance of the collaborative positioning system. By fusing vehicle-to-vehicle relative distances from different sources, the positioning system have higher robustness and accuracy.

### CROSS-REFERENCE TO RELATED APPLICATION

This application claims priority to Chinese Patent Application No. 202410724047.6, filed on Jun. 5, 2024, which is herein incorporated by reference in its entirety.

### TECHNICAL FIELD

The disclosure belongs to the field of intelligent connected vehicle positioning technologies, relates to multi-vehicle collaborative positioning method, and more particularly to a fault-tolerant intelligent connected vehicle collaborative positioning method and a fault-tolerant intelligent connected vehicles collaborative positioning system.

### BACKGROUND

Existing intelligent connected vehicle collaborative positioning technology usually relies on sensors such as global navigation satellite system (GNSS) sensors, ranging sensors, and vehicle-to-vehicle (V2V) communication devices. Pose and sensor information of a neighboring vehicle can be obtained through the V2V communication. Accurate vehicle collaborative positioning can be achieved by fusing the sensor information of the vehicle itself and the neighboring vehicle. However, in the existing positioning framework, the relative distance measurement between vehicles may be affected by many factors, such as hardware or software failures and obstacles, which may cause large errors or even failures. Since the main vehicle depends on the position information of the neighboring vehicle and the relative distance between the main vehicle itself and the neighboring vehicle when the main vehicle updates its own position, when there is a serious error in the distance between the vehicles, it will affect the accuracy and robustness of the entire collaborative positioning system. Therefore, in the collaborative positioning process, it is necessary to detect the correctness and validity of the information obtained by each sensor or device in real time, and correct erroneous information. However, the introduction of different fusion strategies and failure detection algorithms increases the complexity of the system, which requires more computing resources and processing ability, and may increase the complexity of system design and implementation. In addition, this technology cannot solve the problem of communication delay affecting the positioning system during the V2V communication.

### SUMMARY

An objective of the disclosure is to provide a fault-tolerant intelligent connected vehicle collaborative positioning method and system, to overcome a problem of decreased positioning accuracy caused by malfunctioning vehicle distance sensors in the related art.

A fault-tolerant intelligent connected vehicle collaborative positioning method includes the follows:
S1, collecting information of longitude, latitude and altitude of a current position of a vehicle (i.e., a target vehicle), data of angular velocity, traveling velocity, acceleration, wheel speed, steering angle and mileage of the vehicle, and an estimated value of a relative distance between the vehicle and a collaborative vehicle in real time;
S2, pre-processing the information of longitude, latitude and altitude of the current position of the vehicle, and the data of angular velocity, traveling velocity, acceleration, wheel speed, steering angle and mileage of the vehicle to obtain pre-processed information of longitude, latitude and altitude of the current position of the vehicle and pre-processed data of angular velocity, traveling velocity, acceleration, wheel speed, steering angle and mileage of the vehicle; and calibrating the estimated value of the relative distance between the vehicle and the collaborative vehicle to obtain calibrated a calibrated estimated value of the relative distance between the vehicle and the collaborative vehicle; and
S3, performing iterative fusion of Gaussian belief propagation on the pre-processed information of longitude, latitude and altitude of the current position of the vehicle, the pre-processed data of angular velocity, traveling velocity, acceleration, wheel speed, steering angle and mileage of the vehicle and the calibrated estimated value to obtain a resultant position of the vehicle.

In an exemplary embodiment, the fault-tolerant intelligent connected vehicle collaborative positioning method further includes:
matching, based on the resultant position of the vehicle, a map to determine road signs, traffic signals and lane positions;
evaluating a relative position between obstacles ahead and the vehicle based on the resultant position of the vehicle; and
planning a path of the vehicle based on the road signs, the traffic signals, the lane positions and the relative position between obstacles ahead and the vehicle.

In an embodiment, a coordinate of the vehicle, corresponding to the information of longitude, latitude and altitude of the current position of the vehicle, in a longitude-latitude-altitude (LLA) coordinate system is converted to a coordinate of the vehicle in an east-north-up (EDU) coordinate system before positioning calculation.

In an embodiment, the coordinate of the vehicle in the LLA coordinate system is converted to the coordinate of the vehicle in an Earth-centered Earth-fixed (ECEF) coordinate system through the following formula:

$$\{ \begin{matrix}{x}_{ecef} & = ( N + alt ) cos ( lat ) cos ( lon ) \\ {y}_{ecef} & = ( N + alt ) cos ( lat ) sin ( lon ) \\ {z}_{ecef} & = ( N ( 1 - {e}^{2} ) + alt ) sin ( lat )\end{matrix} ;$$

where N represents a prime vertical radius of curvature of a reference ellipsoid, and e represents eccentricity of ellipse.

The coordinate in the ECEF coordinate system is converted to the coordinate in the ENU coordinate system.

In an embodiment, in response to there being no fault occurring in on-board ranging sensors of the vehicle being as a host vehicle and the collaborative vehicle being as a neighboring vehicle, a relative distance information obtained by the on-board ranging sensors of the host vehicle, a relative distance information obtained by the ranging sensor of the neighboring vehicle, and a relative distance information obtained by V2V communication are combined to obtain the estimated value of the relative distance between the vehicle and the collaborative vehicle; and in response to there being fault occurring in the on-board ranging sensors of the vehicle being as the host vehicle and the collaborative vehicle being as the neighboring vehicle, when the on-board ranging sensor of the host vehicle fails, the relative distance information obtained by the on-board ranging sensor of the neighboring vehicle and the relative distance information obtained by V2V communication are fused to obtain the estimated value of the relative distance between the target vehicle and the collaborative vehicle.

In an embodiment, the information of longitude, the latitude and altitude of the current position of the vehicle are obtained from a GNSS sensor, and data of the angular velocity, traveling velocity, acceleration, wheel speed, steering angle and mileage of the vehicle are obtained from an inertial measurement unit (IMU) chip.

In an embodiment, the estimated value of the relative distance between the vehicle and the collaborative vehicle is obtained through a perception sensor module.

A fault-tolerant intelligent connected vehicle collaborative positioning system includes a data collection module, a data pre-processing module and a system positioning module.

The data collection module is configured to collect information of longitude, latitude and altitude of a current position of a vehicle, data of angular velocity, traveling velocity, acceleration, wheel speed, steering angle and mileage of the vehicle, and an estimated value of a relative distance between the vehicle and a collaborative vehicle in real time.

The data pre-processing module is configured to pre-process the information of longitude, latitude and altitude of the current position of the target vehicle, and the data of angular velocity, traveling velocity, acceleration, wheel speed, steering angle and mileage of the target vehicle to obtain pre-processed information of longitude, latitude and altitude of the current position of the target vehicle, and the data of angular velocity, traveling velocity, acceleration, wheel speed, steering angle and mileage of the target vehicle; and calibrate the estimated value of the relative distance between the target vehicle and the collaborative vehicle to obtain calibrated estimated value of the relative distance between the target vehicle and the collaborative vehicle.

The system positioning module is configured to perform iterative fusion of Gaussian belief propagation on the pre-processed information of longitude, latitude and altitude of the current position of the target vehicle, and the data of angular velocity, traveling velocity, acceleration, wheel speed, steering angle and mileage of the target vehicle and the calibrated estimated value to obtain a resultant position of the target vehicle.

In an exemplary embodiment, the perception sensor module, the data collection module, the data pre-processing module, and the system positioning module are embodied by at least one processor and at least one memory coupled to the at least one processor, and the at least one memory stores programs executable by the at least one processor.

In the embodiment, the hardware implementation of the data collection module, the data preprocessing module, and the system positioning module includes multiple key devices. The data collection device, exemplified by a combined navigation system (GNSS+inertial navigation), includes a high-precision MEMS combined navigation system and a GNSS antenna that receives satellite signals. First, the combined navigation system and the industrial control computer are installed and fixed in the rear compartment of the vehicle, connected to the GNSS antenna via a feed line to ensure stable data transmission. The GNSS antenna is installed at the highest point of the autonomous vehicle to reduce signal obstruction. The LiDAR is mounted at the central position on the vehicle's roof to ensure 360-degree omnidirectional perception, avoiding obstruction from the vehicle body or other sensors, and providing accurate relative position information. Furthermore, the CPU processor installed within the in-vehicle computing unit is responsible for real-time execution of sensor data processing and positioning algorithms, and is connected to memory devices RAM that store real-time collected data and positioning algorithms. The LTE-V communication device is integrated into the in-vehicle computing unit and connects with other vehicles via 5G technology, supporting real-time updates of traffic information sharing and collaborative operations. All hardware devices are connected to the in-vehicle computing unit via a high-speed communication bus, enabling data transmission and fusion. The installation and layout of the hardware devices are precisely designed to ensure sensor accuracy and system collaboration.

In an embodiment, a coordinate of the vehicle, corresponding to the information of longitude, latitude and altitude of the current position of the vehicle, in a LLA coordinate system is converted to a coordinate of the vehicle in an EDU coordinate system before positioning calculation.

In an embodiment, in response to there being no fault occurring in on-board ranging sensors of the vehicle being as a host vehicle and the collaborative vehicle being as a neighboring vehicle, a relative distance information obtained by the on-board ranging sensors of the host vehicle, a relative distance information obtained by the ranging sensor of the neighboring vehicle, and a relative distance information obtained by V2V communication are combined to obtain the estimated value of the relative distance between the vehicle and the collaborative vehicle; and in response to there being fault occurring in the on-board ranging sensors of the vehicle being as the host vehicle and the collaborative vehicle being as the neighboring vehicle, when the on-board ranging sensor of the host vehicle fails, the relative distance information obtained by the on-board ranging sensor of the neighboring vehicle and the relative distance information obtained by V2V communication are fused to obtain the estimated value of the relative distance between the target vehicle and the collaborative vehicle.

Compared to the related art, the disclosure has the following beneficial technical effects.

The disclosure discloses a fault-tolerant intelligent connected vehicle collaborative positioning method, which pre-processes the information of longitude, latitude and altitude of the current position of the vehicle, the data of angular velocity, traveling velocity, acceleration, wheel speed, steering angle and mileage of the vehicle to obtain the pre-processed information of longitude, latitude and altitude of the current position of the vehicle and pre-processed data of angular velocity, traveling velocity, acceleration, wheel speed, steering angle and mileage of the vehicle, calibrates the estimated value of the relative distance between the vehicle and the cooperative vehicle to obtain the calibrated estimated value of the relative distance between the vehicle and the cooperative vehicle; and preforms iterative fusion of Gaussian belief propagation on the pre-processed information of longitude, latitude and altitude of the current position of the vehicle and pre-processed data of angular velocity, traveling velocity, acceleration, wheel speed, steering angle and mileage of the vehicle and the calibrated estimated value to obtain a resultant position of the vehicle. By fusing the measurement values of various on-board sensors of the vehicle including the information of longitude and latitude of the vehicle, the odometer information and the vehicle-to-vehicle distance information, the integrity of the collaborative positioning data is ensured. A fault detection and elimination method is performed in a graph model, which ensures the fault-tolerance of the collaborative positioning system. The vehicle-to-vehicle relative distances from different sources are fused, so that the positioning system have higher robustness and accuracy.

### BRIEF DESCRIPTION OF DRAWINGS

FIG. 1 illustrates a flowchart of a fault-tolerant intelligent connected vehicle collaborative positioning method according to an embodiment of the disclosure.

FIG. 2 illustrates a schematic diagram of a ranging model between vehicles according to an embodiment of the disclosure.

FIG. 3 illustrates a schematic diagram of a factor graph model for vehicle collaborative positioning estimation according to an embodiment of the disclosure.

FIG. 4 illustrates a schematic structural diagram of a fault-tolerant intelligent connected vehicle collaborative positioning system according to an embodiment of the disclosure.

### DETAILED DESCRIPTION OF EMBODIMENTS

In order to enable those skilled in the art to better understand the scheme of the disclosure, the technical scheme in the embodiments of the disclosure will be clearly and completely described below in conjunction with the drawings in the embodiments of the disclosure. Apparently, the described embodiments are merely some of the embodiments of the disclosure, not all of them. Based on the embodiments of the disclosure, all other embodiments obtained by those skilled in the art without creative work should fall within a scope of protection of the disclosure.

It should be noted that terms “first” and “second” in the specification and claims of the disclosure and the above-mentioned drawings are used to distinguish similar objects, and are not necessarily used to describe a specific order or sequence. It should be understood that the data used in this way can be interchanged where appropriate, so that the embodiments of the disclosure described herein can be implemented in an order other than those illustrated or described herein. In addition, the terms “including” and “having” and any variations thereof are intended to cover non-exclusive inclusions, for example, a process, method, system, product or device that includes a series of steps or units is not necessarily limited to those steps or units that are clearly listed, but may include other steps or units that are not clearly listed or inherent to these processes, methods, products or devices.

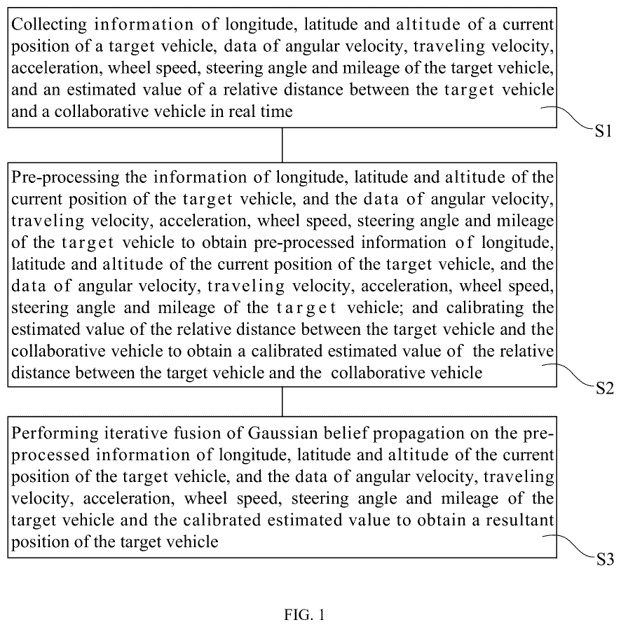

As shown in FIG. 1, the disclosure provides a fault-tolerant intelligent connected vehicle collaborative positioning method, including the following steps S1-S2.

In S1, satellite acquisition, tracking, bit synchronization, frame synchronization and positioning calculation are executed by a GNSS receiving module to obtain information of longitude, latitude and altitude of a current position of a vehicle. Meanwhile, data of angular velocity, traveling velocity, acceleration, wheel speed, steering angle and mileage of the vehicle are obtained through an IMU module. An estimated value of a relative distance between the vehicle and a collaborative vehicle is obtained through a perception sensor module. As an exemplary embodiment, the GNSS receiving module and the IMU module are embodied by at least one processor and at least one memory coupled to the at least one processor, and the at least one memory stores programs executable by the at least one processor.

In S2, when an on-board GNSS sensor receives GNSS information, the received GNSS information is pre-processed to ensure consistency and accuracy of the data.

Data of each sensor is processed by performing coordinate system conversion and sensor calibration on the GNSS information and data values of angular velocity, traveling velocity and acceleration of the vehicle obtained by the IMU module. When the on-board GNSS sensor receives a signal, it gives a coordinate of the vehicle in a LLA coordinate system. Before positioning calculation, the GNSS information needs to be converted to a coordinate in an ENU coordinate system. For any point coordinate P=(alt, lat, lon), lossless conversion of the coordinate system is mainly divided into two steps. The specific conversion process is as follows.

(1) A coordinate (i.e., the point coordinate P) of the vehicle in the LLA coordinate system is converted to a coordinate in an ECEF coordinate system through the following formulas:

$$\{ \begin{matrix}{x}_{ecef} = ( N + alt ) cos ( lat ) cos ( lon ) \\ {y}_{ecef} = ( N + alt ) cos ( lat ) sin ( lon ) \\ {z}_{ecef} = ( N ( 1 - {e}^{2} ) + alt ) sin ( lat )\end{matrix} ;$$

where N represents a prime vertical radius of curvature of a reference ellipsoid, and e represents eccentricity of ellipse.

(2) The coordinate in the ECEF coordinate system is converted to a coordinate in the ENU coordinate system.

1) Any point 0 is taken as a starting position of a base station:

$${0}_{ecef} = ( {x}_{0} , {y}_{0} , {z}_{0} ) ;$$

$${0}_{11 a} = ( {lat}_{0} , {lon}_{0} , {alt}_{0} ) .$$

2) The coordinate of the point P in the ENU coordinate system is as follows:

$$[ \begin{matrix}e \\ n \\ u\end{matrix} ] = [ \begin{matrix}- sin ( {lon}_{0} ) & cos ( {lon}_{0} ) & 0 \\ - sin ( {lat}_{0} ) cos ( {lon}_{0} ) & - sin ( {lat}_{0} ) sin ( {lon}_{0} ) & cos ( {lat}_{0} ) \\ cos ( {lat}_{0} ) cos ( {lon}_{0} ) & cos ( {lat}_{0} ) sin ( {lon}_{0} ) & sin ( {lat}_{0} )\end{matrix} ] \cdot [ \begin{matrix}Δ x \\ Δ y \\ Δ z\end{matrix} ] ;$$

$$where [ \begin{matrix}Δ x \\ Δ y \\ Δ z\end{matrix} ] = [ \begin{matrix}x \\ y \\ z\end{matrix} ] - [ \begin{matrix}{x}_{0} \\ {y}_{0} \\ {z}_{0}\end{matrix} ] .$$

The disclosure calculates on a two-dimensional plane, and a position of a state of a vehicle i at an epoch t is expressed as follows:

$${{s}_{i}}^{( t )} = {[ \begin{matrix}{{x}_{i}}^{( t )} & {{y}_{i}}^{( t )}\end{matrix} ]}^{T} ;$$

where

$${{x}_{i}}^{( t )}$$

represents an abscissa of the vehicle i on the two-dimensional plane, and

$${{y}_{i}}^{( t )}$$

represents an ordinate of the vehicle i on the two-dimensional plane.

An output of an odometer is as follows:

$${{u}_{i}}^{( t )} = {[ \begin{matrix}{{v}_{i}}^{( t )} & {{w}_{i}}^{( t )}\end{matrix} ]}^{T} ;$$

where the output

$${{u}_{i}}^{( t )}$$

is composed of a velocity

$${{v}_{i}}^{( t )}$$

and a rotation rate

$${{w}_{i}}^{( t )} .$$

A movement model output by the odometer is as follows:

$${{v}_{i}}^{( t )} = \frac{1}{Δ t} \sqrt{{( {x}_{i}^{t + 1} - {x}_{i}^{t} )}^{2} + {( {y}_{i}^{t + 1} - {y}_{i}^{t} )}^{2}} + {n}_{v} , {n}_{v} ∼ ( 0 , {σ}_{v}^{2} ) .$$

The distance between vehicles are measured by a ranging sensor, which is expressed as follows:

$${\tilde{r}}_{ij} = \sqrt{{( {x}_{i} - {x}_{j} )}^{2} + {( {y}_{i} - {y}_{j} )}^{2}} + {n}_{r} , {n}_{r} ∼ ( 0 , {σ}_{r}^{2} ) .$$

The disclosure uses Gaussian distribution to fit non-Gaussian noise.

The above obtained information is input into a Gaussian confidence propagation (GBP) algorithm module for calculation. In the GBP algorithm module, all variable nodes are represented by Gaussian distribution, thus the positioning state distribution of the vehicle i is expressed as follows:

$$p ( {s}_{i} ) = c exp [ - \frac{1}{2} {( {s}_{i} )}^{T} {Φ}_{{s}_{i}} {s}_{i} + {( {η}_{{s}_{i}} )}^{T} {s}_{i} ] ;$$

where c represents a constant, Φₛ_{ᵢ} represents an information matrix, which is an inverse of a covariance matrix of a corresponding state, and ηₛ_{ᵢ} represents an information vector.

Observation between the vehicle i and the vehicle j is modeled as a function node, and the corresponding information matrix is expressed as follows:

$${η}_{{s}_{i}} = {( {J}_{{\hat{s}}_{i}} )}^{T} {Φ}_{{s}_{i}}^{′} [ {J}_{{\hat{s}}_{i}} {\hat{s}}_{i} + {z}_{ij} - h ( {\hat{s}}_{i} , {\hat{s}}_{j} ) ] ;$$

$${Φ}_{{s}_{i}}^{′} = {( {J}_{{\hat{s}}_{i}} )}^{T} {Φ}_{{s}_{i}}^{′} {J}_{{\hat{s}}_{i}} {\hat{s}}_{i} ;$$

where

$${Φ}_{{s}_{i}}^{′}$$

represents an observed information matrix, ηₛ_{ᵢ} represents an observed information vector, and Jₛ_{ᵢ} represents a Jacobian matrix of observation function.

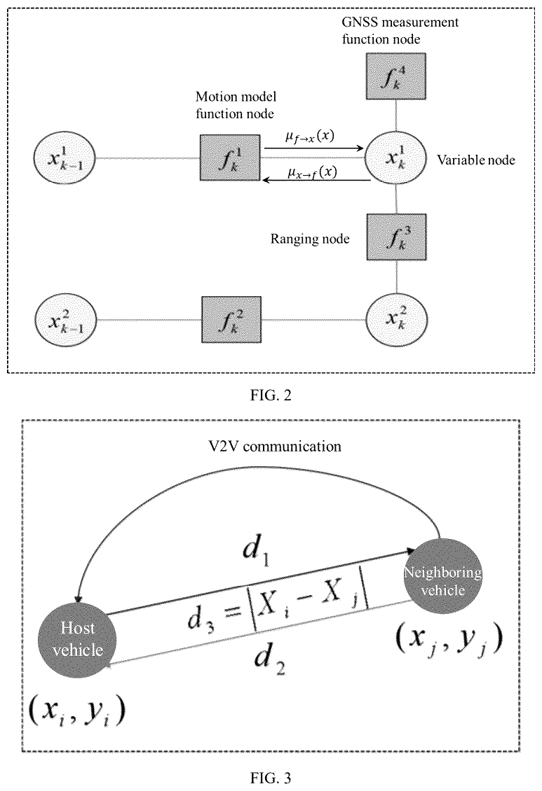

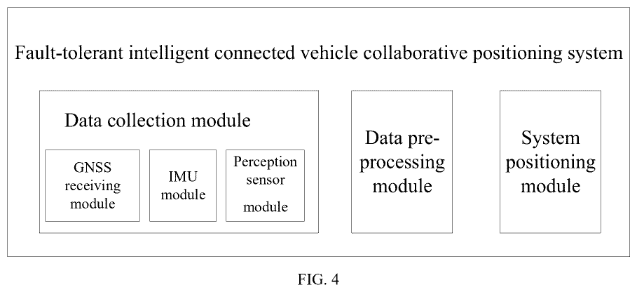

As shown in FIG. 2, FIG. 2 illustrates a schematic diagram of a factor graph model for vehicle collaborative positioning estimation. In FIG. 2, all variable nodes will broadcast outgoing messages to the connected functional nodes. In an embodiment, all the functional nodes will send messages back to the connected variable nodes to obtain marginalized probability density estimate of the estimated state, so that a marginalized probability density estimate state can be obtained.

After inputting the data into the GBP algorithm module, fault detection and elimination of each observation data is performed, and a relative ranging fusion strategy of different sources is adjusted according to the residual. The GBP algorithm module can perform distributed edge fault detection and elimination algorithm (FDE) on the edge corresponding to the positioning observation. Considering that the edge connects the variable node (ŝᵢ, ŝᵢ), the residual of this edge eᵢⱼ is expressed as follows:

$${γ}_{{e}_{i j}} = {e}_{i j} {z}_{i j} - h ( {\hat{s}}_{i} , {\hat{s}}_{j} ) .$$

A covariance of the residuals is expressed as follows:

$${S}_{{e}_{i j}} = {H}_{{\hat{s}}_{i} , {\hat{s}}_{j}} [ \begin{matrix}{P}_{{s}_{i}} & {P}_{{s}_{i} , {s}_{j}} \\ {P}_{{s}_{j} , {s}_{i}} & {P}_{{s}_{j}}\end{matrix} ] {( {H}_{{\hat{s}}_{i} , {\hat{s}}_{j}} )}^{T} + {σ}_{{z}_{i j}}^{2} ;$$

where H_{ŝ}_{ᵢ}_{ŝ}_{ⱼ} represents an observation matrix based on ŝᵢ and ŝⱼ,

$$[ \begin{matrix}{P}_{{s}_{i}} & {P}_{{s}_{i} , {s}_{j}} \\ {P}_{{s}_{j} , {s}_{i}} & {P}_{{s}_{j}}\end{matrix} ]$$

represents a corresponding covariance matrix, and

$${σ}_{{z}_{i j}}^{2}$$

represents an observed covariance.

The w-test is used to detect erroneous observation results. A fault detection equation is expressed as follows:

$${w}_{{e}_{ij}} = \frac{{γ}_{{e}_{ij}}}{\sqrt{{s}_{{e}_{ij}}}} .$$

In the normal case without erroneous observations, the test statistic We follows the standard normal distribution, that is, wₑᵢⱼ˜N(0, 1). When the edge eᵢⱼ is affected by the erroneous observations, the test statistic will not follow the standard normal distribution, and a detection threshold is calculated by the following formula:

$$\frac{{P}_{FA}}{2} = \frac{2}{\sqrt{2 π}} {\int }_{{T}_{w}}^{∞} {e}^{\frac{{x}^{2}}{2}} dx ;$$

where P_{FA} represents a probability of false alarm required by the positioning system.

The determination rule of the test statistic is as follows:

$$\{ \begin{matrix}{w}_{{e}_{i j}} \leq {T}_{w} , normal \\ {w}_{{e}_{i j}} > {T}_{w} , faulty\end{matrix} .$$

That is, when the statistic Wen is smaller than or equal to the threshold T_{w}, it means that the observation is within a normal error range. When the statistic wₑᵢⱼ is greater than the threshold T_{w}, it means that the observation has a fault. At this time, it needs to isolate the fault value. The specific isolation measure is to disconnect the corresponding edge in the factor graph when a fault value is detected, so that the message of the corresponding edge will not be propagated to other nodes with the message.

In a vehicle self-organizing network, each vehicle is equipped with the on-board ranging sensor, and the on-board ranging sensor can obtain the ranging observation between the vehicle and the neighboring vehicle. For the distance observation between two vehicles, there are usually relative distance measurements from different sources, as shown in FIG. 3, the relative distance can be expressed as follows:

$$\{ \begin{matrix}{d}_{1} = {d}_{i j} \\ {d}_{2} = {d}_{j i} \\ {d}_{3} = \vert {\hat{x}}_{{i}_{t \vert t - 1}}^{-} - {\hat{x}}_{{j}_{t \vert t - 1}}^{-} \vert\end{matrix} ;$$

where d₁ represents a relative distance between the two vehicles measured by the on-board ranging sensor of the host vehicle, d₂ represents a relative distance between the two vehicles measured by the on-board ranging sensor of the neighboring vehicle, and d₃ represents a relative distance between the two vehicles predicted by V2V communication.

In response to there being no fault occurring in on-board ranging sensors of the vehicle being as a host vehicle and the collaborative vehicle being as a neighboring vehicle, relative distance information obtained by the on-board ranging sensor of the host vehicle, relative distance information obtained by the on-board ranging sensor of the neighboring vehicle, and relative distance information obtained by vehicle-to-vehicle (V2V) communication are combined to accurately estimate the relative distance, and a formula for estimating the relative distance is as follows:

$$D = \frac{\vert {d}_{1} - {d}_{3} \vert}{\vert {d}_{1} - {d}_{3} \vert + \vert {d}_{2} - {d}_{3} \vert} * {d}_{1} + \frac{\vert {d}_{2} - {d}_{3} \vert}{\vert {d}_{1} - {d}_{3} \vert + \vert {d}_{2} - {d}_{3} \vert} * {d}_{2} .$$

In response to there being fault occurring in the on-board ranging sensors of the vehicle being as the host vehicle and the collaborative vehicle being as the neighboring vehicle, when the on-board ranging sensor of the host vehicle fails, the relative distance information obtained by the on-board ranging sensor of the neighboring vehicle and the relative distance information obtained by V2V communication are fused to obtain the estimated value of the relative distance between the vehicle and the collaborative vehicle, to thereby avoid applying erroneous data to the collaborative positioning estimation, and a formula for estimating the relative distance is as follows:

$$D = \frac{\vert {d}_{2} - {d}_{3} \vert}{\vert {d}_{2} - {d}_{3} \vert + 1} * {d}_{2} + \frac{1}{\vert {d}_{2} - {d}_{3} \vert + 1} * {d}_{3} .$$

The processed GNSS, IMU and relative measurement data are iteratively fused using the Gaussian confidence propagation algorithm on a new factor graph to obtain a resultant position of the vehicle.

A position of each variable node has two degrees of freedom on the two-dimensional plane, which is as follows:

$${X}_{i} ( {x}_{i} , {y}_{i} ) .$$

The function factor is the two-dimension Euclidean relative attitude measurement between two nodes, and its measurement function is as follows:

$${h}_{s} ( {x}_{i} , {y}_{i} ) = {x}_{i} - {y}_{i} .$$

The measurement accuracy is as follows:

$${Λ}_{s} = [ \begin{matrix}\frac{1}{{σ}^{2}} & 0 \\ 0 & \frac{1}{{σ}^{2}}\end{matrix} ] .$$

The iterative process of the algorithm includes the following steps. First, a probability distribution of each node is initialized. Second, information transmission is iterated. In each iteration, each node sends a message to its neighboring nodes, and the message contains the impact of the node on the neighboring nodes. The receiving node updates its own probability distribution based on the received message. This update process reflects the interdependent information transmission between variables. Through continuous iteration, the information transmission between nodes gradually tends to be stable, and the probability distribution converges to a consistent state. Finally, the algorithm provides an estimate of the probability distribution of unknown variables and realizes the inference of the entire graph model.

When the vehicle i observe the vehicle j through the on-board ranging sensor, observed function node can receive message from the connected variable nodes. After receiving the message from the node i, the corresponding cascade information vector and the information matrix are as follows:

$$\begin{matrix}{η}_{{z}_{i j}} = {[ {η}_{{s}_{i}}^{T} , {η}_{{s}_{j}}^{T} , + {η}_{{s}_{j} \to {z}_{i j}}^{T} ]}^{T} ; \\ {Φ}_{{z}_{i j}}^{′} = [ \begin{matrix}{Φ}_{{s}_{i}}^{′} & {Φ}_{{s}_{i} , {s}_{j}}^{′} \\ {Φ}_{{s}_{j} , {s}_{i}}^{′} & {Φ}_{{s}_{i}}^{′} + {Φ}_{{s}_{i} , {z}_{ij}}^{′}\end{matrix} ] .\end{matrix}$$

All variable nodes collect incoming messages from all connected function nodes. After many iterations of message passing, each variable node can calculate the mean and covariance of its localization as follows:

$$\begin{matrix}{\hat{μ}}_{{s}_{i}} = {Φ}_{{s}_{i}}^{- 1} {η}_{{s}_{i}} ; \\ {\hat{P}}_{{s}_{i}} = {Φ}_{{s}_{i}}^{- 1} .\end{matrix}$$

The observation of various sensors on the vehicle are input into the algorithm process module integrated with the confidence propagation algorithm, which is an iterative reasoning algorithm for graph model inference. The confidence propagation algorithm is based on the probabilistic graph model, gradually updates the probability distribution of nodes by passing information between nodes in the graph, and finally achieves the inference of unknown variables. The confidence propagation algorithm optimizes the process of information transmission and updating between nodes through repeated iterations, so that it gradually converges and provides an effective probabilistic inference framework.

The disclosure implements a failure detection and relative distance fusion strategy to address the problem of failure of the ranging sensor of the host vehicle under the Gaussian confidence propagation positioning framework. When the sensor is working normally, the relative distance information obtained by the on-board ranging sensors of the host vehicle and the neighboring vehicle, and V2V communication is combined to accurately estimate the relative distance. When the host vehicle ranging sensor fails, the system intelligently adjusts the fusion strategy and still uses V2V communication data to maintain the continued effectiveness of collaborative positioning. In addition, an edge detection algorithm based on the GBP framework is introduced to monitor the failure of the ranging sensor of the host vehicle through w-detection, and then the fusion strategy is adjusted in real time.

What is claimed is:

1. A fault-tolerant intelligent connected vehicle collaborative positioning method, comprising:
S1, collecting information of longitude, latitude and altitude of a current position of a target vehicle, data of angular velocity, traveling velocity, acceleration, wheel speed, steering angle and mileage of the target vehicle, and an estimated value of a relative distance between the target vehicle and a collaborative vehicle in real time;
S2, pre-processing the information of longitude, latitude and altitude of the current position of the target vehicle, and the data of angular velocity, traveling velocity, acceleration, wheel speed, steering angle and mileage of the target vehicle to obtain pre-processed information of longitude, latitude and altitude of the current position of the target vehicle and pre-processed data of angular velocity, traveling velocity, acceleration, wheel speed, steering angle and mileage of the target vehicle; and calibrating the estimated value of the relative distance between the target vehicle and the collaborative vehicle to obtain a calibrated estimated value of the relative distance between the target vehicle and the collaborative vehicle; and
S3, performing iterative fusion of Gaussian belief propagation on the pre-processed information of longitude, latitude and altitude of the current position of the target vehicle, the pre-processed data of angular velocity, traveling velocity, acceleration, wheel speed, steering angle and mileage of the target vehicle and the calibrated estimated value to obtain a resultant position of the target vehicle.

2. The fault-tolerant intelligent connected vehicle collaborative positioning method as claimed in claim 1, wherein a coordinate of the target vehicle, corresponding to the information of longitude, latitude and altitude of the current position of the target vehicle, in a longitude-latitude-altitude (LLA) coordinate system is converted to a coordinate of the target vehicle in an east-north-up (EDU) coordinate system before positioning calculation.

3. The fault-tolerant intelligent connected vehicle collaborative positioning method as claimed in claim 2, wherein the coordinate of the target vehicle in the LLA coordinate system is first converted to a coordinate of the target vehicle in an Earth-centered Earth-fixed (ECEF) coordinate system, and then the coordinate of the target vehicle in the ECEF coordinate system is converted to the coordinate of the target vehicle in the EDU coordinate system.

4. The fault-tolerant intelligent connected vehicle collaborative positioning method as claimed in claim 1, wherein in response to there being no fault occurring in on-board ranging sensors of the vehicle being as a host vehicle and the collaborative vehicle being as a neighboring vehicle, relative distance information obtained by the on-board ranging sensor of the host vehicle, relative distance information obtained by the on-board ranging sensor of the neighboring vehicle, and relative distance information obtained by vehicle-to-vehicle (V2V) communication are combined to obtain the estimated value of the relative distance between the target vehicle and the collaborative vehicle;
in response to there being fault occurring in the on-board ranging sensors of the vehicle being as the host vehicle and the collaborative vehicle being as the neighboring vehicle, when the on-board ranging sensor of the host vehicle fails, the relative distance information obtained by the on-board ranging sensor of the neighboring vehicle and the relative distance information obtained by V2V communication are fused to obtain the estimated value of the relative distance between the target vehicle and the collaborative vehicle.

5. The fault-tolerant intelligent connected vehicle collaborative positioning method as claimed in claim 1, wherein the information longitude, latitude and altitude of the current position of the target vehicle are obtained from a global navigation satellite system (GNSS) sensor, and the data of angular velocity, traveling velocity, acceleration, wheel speed, steering angle and mileage of the target vehicle are obtained from an inertial measurement unit (IMU) chip.

6. The fault-tolerant intelligent connected vehicle collaborative positioning method as claimed in claim 1, wherein the estimated value of the relative distance between the target vehicle and the collaborative vehicle is obtained through a perception sensor module.

7. A fault-tolerant intelligent connected vehicle collaborative positioning system, comprising:
a data collection module, configured to collect information of longitude, latitude and altitude of a current position of a target vehicle, data of angular velocity, traveling velocity, acceleration, wheel speed, steering angle and mileage of the target vehicle, and an estimated value of a relative distance between the target vehicle and a collaborative vehicle in real time;
a data pre-processing module, configured to pre-process the information of longitude, latitude and altitude of the current position of the target vehicle, and the data of angular velocity, traveling velocity, acceleration, wheel speed, steering angle and mileage of the target vehicle to obtain pre-processed information of longitude, latitude and altitude of the current position of the target vehicle, and the data of angular velocity, traveling velocity, acceleration, wheel speed, steering angle and mileage of the target vehicle; and calibrate the estimated value of the relative distance between the target vehicle and the collaborative vehicle to obtain calibrated estimated value of the relative distance between the target vehicle and the collaborative vehicle; and
a system positioning module, configured to perform iterative fusion of Gaussian belief propagation on the pre-processed information of longitude, latitude and altitude of the current position of the target vehicle, and the data of angular velocity, traveling velocity, acceleration, wheel speed, steering angle and mileage of the target vehicle and the calibrated estimated value to obtain a resultant position of the target vehicle.

8. The fault-tolerant intelligent connected vehicle collaborative positioning system as claimed in claim 7, wherein a coordinate of the target vehicle, corresponding to the information of longitude, latitude and altitude of the current position of the target vehicle, in a LLA coordinate system is converted to a coordinate of the target vehicle in an EDU coordinate system before positioning calculation.

9. The fault-tolerant intelligent connected vehicle collaborative positioning system as claimed in claim 7, wherein in response to there being no fault occurring in on-board ranging sensors of the vehicle being as a host vehicle and the collaborative vehicle being as a neighboring vehicle, a relative distance information obtained by the on-board ranging sensor of the host vehicle, a relative distance information obtained by the on-board ranging sensor of the neighboring vehicle, and a relative distance information obtained by vehicle-to-vehicle (V2V) communication are combined to obtain the estimated value of the relative distance between the target vehicle and the collaborative vehicle; and
in response to there being fault occurring in the on-board ranging sensors of the vehicle being as the host vehicle and the collaborative vehicle being as the neighboring vehicle, when the on-board ranging sensor of the host vehicle fails, the relative distance information obtained by the on-board ranging sensor of the neighboring vehicle and the relative distance information obtained by V2V communication are fused to obtain the estimated value of the relative distance between the target vehicle and the collaborative vehicle.

10. The fault-tolerant intelligent connected vehicle collaborative positioning system as claimed in claim 7, wherein the data collection module comprises a GNSS receiving module and an IMU module, the GNSS receiving module is configured to obtain the information of longitude, latitude and altitude of the current position of the target vehicle, and the IMU module is configured to obtain the data of angular velocity, traveling velocity, acceleration, wheel speed, steering angle and mileage of the target vehicle.
